(19) United States
(12) Patent Application Publication
(10) Pub. No.: US 2020/0216680 A1
(43) Pub. Date: Jul. 9, 2020

(54) COATING COMPOSITION FOR SURFACE TEMPERATURE REDUCTION

(71) Applicant: SWIMC LLC, Clevland, OH (US)

(72) Inventors: Brian SCHINDLY, Avon Lake, OH (US); Terry JORDAN, Parma, OH (US); Maddi FERRARA, Willoughby, OH (US); Michael VETRICK, Brunswick, OH (US)

(21) Appl. No.: 16/825,153

(22) Filed: Mar. 20, 2020

Related U.S. Application Data
(63) Continuation-in-part of application No. 16/070,115, filed on Jul. 13, 2018.
(60) Provisional application No. 62/279,400, filed on Jan. 15, 2016.
(60) Provisional application No. 62/822,246, filed on Mar. 22, 2019.

(51) Int. Cl. C09D 5/33; C09D 7/40; C09D 7/61; C09D 7/43; C09D 7/65; C09D 121/02; C04B 41/00; C04B 41/63; C04B 41/48

(52) U.S. Cl. CPC C09D 5/004; C09D 7/70; C09D 7/61; C09D 7/43; C04B 41/4857; C09D 121/02; C04B 41/009; C04B 41/63; C09D 7/65

(57) ABSTRACT

The present technology provides a coating composition suitable for maintaining a cooler surface temperature in the presence of a UV source, e.g., the sun, as compared with a conventional coating composition. The present coating composition can reflect the sun's rays to provide a cooler surface when compared to other compositions of similar colors. The coating can be used to coat a variety of substrates and can be used, for example, as a coating for walking surfaces. When applied to a walking surface, the coating composition may provide a cooler surface that is barefoot-friendly, even in the presence of the sun or other strong UV source.

### CROSS-REFERENCE TO RELATED APPLICATIONS

The present application claims priority, as a continuation-in-part application, to U.S. patent application Ser. No. 16/070,115 filed on Jul. 13, 2018, which is a national stage application of International Application PCT/US2017/013771 filed on Jan. 17, 2017, which claims priority to and the benefit of U.S. Provisional Application 62/279,400 filed on Jan. 15, 2016, each of which is incorporated herein by reference in its entirety. The present application also claims priority to and the benefit of U.S. Provisional Application 62/822,246 filed on Mar. 22, 2019, the disclosure of which is incorporated herein by reference in its entirety.

### FIELD

The present technology relates to a coating composition for reducing the surface temperature of a substrate to which it is applied.

### BACKGROUND

In general, surfaces exposed to sources of UV-radiation can become hot to the touch due, at least in part, to the absorption of the light rays by the surface. Dark surfaces, such as black-colored surfaces, can absorb nearly all wavelengths of light. When the light radiation is absorbed, it converts to other forms of energy, usually heat, which is then emitted by the surface. Accordingly, the darker an object, the better it emits heat and therefore the hotter it is to the touch.

Anyone walking across asphalt on a hot, sunny day knows first-hand the extent of the heat of the asphalt. Additionally, a swimmer can face the same issues when he exits a pool on a hot, sunny day, only to place his or her bare feet on the scalding hot concrete outside of the pool and quickly dash into the shade for relief. Apart from being unpleasant, these hot surfaces can go as far as to damage the feet of adults and children who walk across them, not to mention the footpads of dogs, cats, and other animals.

There are coating compositions attempting to combat these problems. The current coating compositions incorporate infrared reflective pigment technologies to minimize heat build in coated surfaces exposed to sunlight. However, this type of composition only addresses one issue relating to surfaces in the sun and therefore is limited in its ability to drop the temperature of a coated surface. Further, the infrared reflective pigments are expensive and are only available in limited colors, thus limiting options available to potential customers. Other compositions fail to reflect and/or scatter UV light as a means for reducing the temperature of a coated surface.

Accordingly, there exists a need for an improved coating composition that is cost-effective, available in a wide range of colors, and allows for improved surface temperature reduction through various means.

### SUMMARY

The present technology relates to a coating composition suitable for maintaining a cooler surface temperature in the presence of a UV source, e.g., the sun, as compared with a control coating composition. The coating composition can reflect the sun's rays to provide a cooler surface when compared to control compositions of similar colors. The composition may be used to coat a variety of substrates and may be used, for example, as a coating for walking surfaces. When applied to a walking surface, the coating can provide a much cooler surface that is barefoot-friendly, even in the presence of the sun or other strong UV-ray sources.

The coating composition of the present technology may include a carrier, a binder, a thickener, a spherical-shaped glass, and an additive. In an embodiment, the coating composition may include a filler and/or a colorant. The composition may include a filler. In an embodiment, the coating composition does not include raw umber. In an embodiment, the coating composition does not include carbon black. In one embodiment, the coating composition is free of raw umber. In one embodiment, the composition is free of both carbon black and raw umber.

In an embodiment, the composition may include about 0.1 to about 5 wt. % thickener. The thickener may be selected from any appropriate material, including, but not limited to, hydroxyethyl cellulose.

In an embodiment, the composition may include about 10 to about 20 wt. % glass. The glass may be selected from any appropriate material including, but not limited to, spherical-shaped silicate glass or borosilicate.

In an embodiment, the composition may exhibit high film build.

In an embodiment, the composition does not include carbon black.

In an embodiment, the composition does not include raw umber.

In an aspect, the present technology discloses an article having at least one surface coated with the coating composition. The article may be made of any appropriate material, including, but not limited to, concrete, brick, stucco, asphalt, wood, metal, plaster, roof shingles, or plastic.

The coated surface of the article has a solar reflectance value of at least 25% more than a surface coated with a conventional coating. Further, the coated surface may have a reduced surface temperature of over 25° F. as compared to a surface coated with a conventional coating. In an embodiment, the spherical-shaped glass of the coating composition reflects UV light. In an embodiment, the high film build reflects UV light.

In one aspect, the present technology provides a process for preparing a coating composition including providing a carrier, a binder, a thickener, a spherical-shaped glass, and an additive and mixing the aforementioned components together. In an embodiment, the coating composition may develop a high film build.

In one aspect, the coating composition includes a carrier, a binder, a thickener configured to create a high film build, and an additive.

In an aspect, the coating composition includes a carrier, a binder, a thickener, and no carbon black.

These and other aspects and embodiments are further understood with reference to the following detailed description.

### BRIEF DESCRIPTION OF THE DRAWINGS

FIG. 1 is a cross-sectional view of the coating composition on a surface;

FIG. 2 is a boxplot comparing the temperature differences between a control and a prototype coating composition after 30 minutes of heat source exposure in a laboratory;

FIG. 3 is a bar chart comparing the temperature differences of 18 color variations of a control and of a prototype coating composition after 30 minutes of heat source exposure in a laboratory;

FIG. 4 is a bar chart comparing the percentage temperature differences of 18 color variations of a control and of a prototype coating composition after 30 minutes of heat source exposure in a laboratory;

FIG. 5 is a boxplot comparing the temperature differences between a control and a prototype coating composition after 240 minutes of heat source exposure in a laboratory;

FIG. 6 is a bar chart comparing the temperature differences of 6 color variations of a control and of a prototype coating composition after 240 minutes of heat source exposure in a laboratory;

FIG. 7 is a boxplot comparing the temperature differences between a control and a prototype coating composition on exposure over concrete;

FIG. 8 is a boxplot comparing the temperature differences between 5 color variations of a control and of a prototype coating composition on exposure over concrete;

FIG. 9 is a boxplot comparing the temperature differences between 5 color variations of a control and of a prototype coating composition on exposure over concrete;

FIG. 10 is a boxplot comparing the total solar reflectance of a control versus a prototype coating composition;

FIG. 11 is a bar chart highlighting the total solar reflectance of 17 color variations of a control versus a prototype coating composition;

FIG. 12 is a line chart comparing the temperature difference of prototype compositions and a control;

FIG. 13 is a line chart comparing the temperature difference of prototype compositions;

FIG. 14 is a line chart comparing the temperature difference of prototype compositions;

FIG. 15 is a bar graph comparing the maximum temperature difference of prototype compositions versus a control;

FIG. 16 is a bar graph comparing the maximum temperature difference of prototype compositions versus a control;

FIG. 17 is a line chart comparing the temperature difference of prototype compositions and a control;

FIG. 18 is a line chart comparing the temperature difference of prototype compositions;

FIG. 19 is a line chart comparing the temperature difference of prototype compositions;

FIG. 20 is a line chart comparing the temperature difference of prototype compositions;

FIG. 21 is a bar graph comparing the maximum temperature difference of prototype compositions versus a control;

FIG. 22 is a bar graph comparing the maximum temperature difference of prototype compositions versus a control;

FIG. 23 is a bar graph showing the temperatures of coating compositions of different colors formulated from a white base coating over time compared to bare concrete;

FIG. 24 is a bar graph showing the maximum temperature difference of the coating compositions from FIG. 23 compared to bare concrete;

FIG. 25 is a bar graph showing the temperatures of coating compositions of different colors compared to bare concrete;

FIG. 26 is a bar graph showing the maximum temperature difference of the coating compositions of FIG. 25 compared to bare concrete;

FIG. 27 is a bar graph showing the temperatures of coating compositions of different colors formulated from a white base coating over time compared to bare concrete;

FIG. 28 is a bar graph showing the maximum temperature difference of the coating composition of FIG. 27 compared to bare concrete;

FIG. 29 is a bar graph showing the temperatures of coating compositions of different colors compared to bare concrete; and

FIG. 30 is a bar graph showing the maximum temperature difference of the coating compositions of FIG. 29 compared to bare concrete.

The drawings are not to scale unless otherwise noted. The drawings are for the purpose of illustrating aspects and embodiments of the present technology and are not intended to limit the technology to those aspects illustrated therein. Aspects and embodiments of the present technology can be further understood with reference to the following detailed description.

### DETAILED DESCRIPTION

The present technology provides a coating composition suitable for maintaining a cooler surface temperature in the presence of a UV source, e.g., the sun, as compared with a control coating composition and/or compared to an uncoated surface. Without being bound to any particular theory, the coating composition can reflect the sun's rays to provide a cooler surface when compared to control compositions of similar colors. The coatings can be used to coat a variety of substrates and can be used, for example, as a coating for walking surfaces. When applied to a walking surface, the coating composition may provide a much cooler, slip-resistant surface that is barefoot-friendly, even in the presence of the sun or other strong UV source.

The coating composition of the present technology may include a carrier, a binder, a thickener, a glass, an additive, a filler, and a colorant. Each of such ingredients may comprise a single component or several different components. The coating composition may not include all of the above components. In an embodiment, the composition may not include a thickener. In an embodiment, the composition may not include a glass. In an embodiment, the composition may not include carbon black. In an embodiment, the composition may not include raw umber.

The coating composition may include a carrier component. The carrier is a fluid component which serves to carry all of the other composition components. The carrier is part of the wet composition and usually evaporates as the composition forms a film and dries on a surface. In latex compositions, the carrier is usually water. In oil-based compositions, the carrier is usually an organic solvent, including but not limited to, alkylene carbonates, aliphatics, aromatics, alcohols, ketones, ethers, glycols, etc. Non-limiting examples of materials suitable as a carrier include, for example, dimethyl carbonate, Oxsol® 100, Mineral Spirits, and Aromatic Naptha 100. The amount and type of carrier is usually determined by features of the other coating composition components. In an embodiment, the amount of carrier may range from about 10 to about 40 wt. %, from about 15 to about 35 wt. %, from about 20 to about 30 wt. %, and even about 22 to about 26 wt. % of the composition. In an embodiment, the carrier may be approximately 23 wt. % of the composition. In an embodiment, the carrier may be approximately 25 wt. % of the composition. It will be appreciated that a plurality of carrier materials may be employed in the compositions and may include different carriers from within a given category (e.g., different alkylene carbonates) and/or carriers from different categories or classes of materials.

The coating composition may include a binder component. The binder component is what causes the composition to form a film on and adhere to a surface. In a latex composition, the binder is a latex resin, usually selected from acrylics, vinyl acrylics, and/or styrene acrylics. Still other binders include urethane fortified acrylics and acrylic-epoxy hybrid materials. In a latex composition, the latex resin particles usually are in a dispersion with water as the carrier. In an embodiment, the binders may be RHOPLEX AC-2829 and ROPAQUE OP-96. In still another embodiment, the binder comprises a 100% self crosslinking acrylic. In an oil-based composition, the binder may be any appropriate material, including, but not limited to, alkyd (polyester resin), alkyd modified with phenolic resin, styrene, vinyl toluene, acrylic monomers, silicone, and polyurethanes. In one embodiment, the binder in an oil-based composition is chosen from a methylmethacrylate, isobutyl methacrylate, or related chemistries. The amount and type of binder is usually determined by features of the other coating composition components. In an embodiment, the amount of binder may range from about 30 to about 60 wt. %, from about 35 to about 55 wt. %, from about 40 to about 50 wt. %, and even from about 42 to about 46 wt. % of the composition. In an embodiment, the binder may be approximately 45 wt. % of the composition. In an embodiment, the binder may be approximately 49 wt. % of the composition.

The coating composition may also include a thickener component. Thickeners are additives which, when added to a carrier in small amounts, raise its viscosity. Typically, the viscosity of the carrier may change from one poise to about 20-100 poises on the addition of about 0.5 to about 4 wt. % based upon solids content of thickener used.

The amount and type of thickener is usually determined by features of the other coating composition components. In an embodiment, the amount of thickener may range from about 0 to about 5 wt. %, from about 0.01 to about 4 wt. %, from about 0.1 to about 3 wt. %, from about 0.2 to about 2 wt. %, and even from about 0.5 to about 1 wt. % of the composition. In an embodiment, the thickener may be approximately 0.4606 wt. % of the composition. In an embodiment, the thickener may be approximately 0.4136 wt. % of the composition.

Thickeners are commonly classified as “natural” or “synthetic.” Examples of suitable natural thickeners include, but are not limited to, casein and alginates. Examples of synthetic thickeners include, but are not limited to, hydroxyethyl cellulose (HEC), alkali soluble emulsions (ASE thickeners), hydrophobically-modified ethylene, oxide urethane (HEUR thickeners), hydrophobically-modified hydroxyethyl cellulose (HMHEC), hydrophoically-modified ethylhydroxyethyl cellulose (HMEHEC), methylethldrooxyethylcellulose (MEHEC), hydrophobically-modified alkali soluble emulsion (HASE), polyether polyol, silicas, talc, clays, cornstarch, sulfonates, saccharides, modified castor oil, etc. Of these, the acrylic thickeners are often preferred as they are not prone to bacterial or fungal attack on storage. Natural or synthetic cellulosic thickeners may also be used. However, when they are used bactericides and fungicides may need to be added to the composition.

The unique thickening properties of thickeners are due to their ability to absorb large quantities of water leading to a great deal of swelling. In the case of acrylic thickeners, this property is achieved by incorporating an acidic monomer, such as methacrylic acid, as a copolymer during the synthesis. The finished polymer, when partially or fully neutralized, swells and takes up water. The neutralizing agents used can be inorganic, such as sodium hydroxide or ammonia, or inorganic, such as amines. The extent of thickening achieved can be further controlled by the addition of solvents such as alcohols, for example, methanol, ethanol and butanol, or ketones such as acetone, methylethyl ketone, or other solvents such as propasol, butyl cellosolve, and/or butyl carbitol. Other solvents, where useable, are generally mentioned in the trade literature supplied by the manufacturer. Additional control of the extent of thickening can be obtained by using different concentrations of the thickener, higher concentrations giving a greater extent of thickening. Increased thickness of a coating composition may improve the heat reflective and scattering properties of an article coating in the composition.

The coating composition may also include a glass component. The glass component may be selected from any appropriate material, including, but not limited to, silicate glasses, such as fused quartz, fused silica glass, vitreous silica glass, soda-lime-silica glass, sodium borosilicate glass, borosilicate glass, lead-oxide glass, crystal glass, aluminosilicate glass, and germanium oxide glass, phosphate glasses, or a combination of two or more thereof.

In an embodiment, the glass is borosilicate glass. Borosilicate glass is a type of glass that includes at least silica, soda, lime, and boron borosilicate. In some embodiments, the glass of the composition includes at least 5% boric acid, at least 8% boric acid, at least 10% boric acid, at least 12% boric acid, at least 15% boric acid, and even at least 18% boric acid. In one embodiment, the borosilicate glass comprises from about 5 to about 20% boric acid. Borosilicate glass has a low coefficient of thermal expansion (˜3×10⁻⁶/° F. at 20° F.), making it generally resistant to thermal shock. The glass may help to form a stable emulsion in the composition. Further, the glass is compatible in the coating composition as it is also non-combustible and nonporous, so it does not absorb resin.

The amount and type of glass is usually determined by features of the other coating composition components. In an embodiment, the glass used in the composition may be SCOTCHLITE K46 glass microspheres or SCOTCHLITE K37 glass microspheres. In an embodiment, the glass may be Q-CEL hollow glass microspheres. In an embodiment, the glass may be SPHERICEL hollow glass microspheres. The glass may be formed in any appropriate shape and size, so long as it has a good crushability factor making it appropriate for being walked on. In an embodiment, the glass is in a rounded or spherical form, e.g., a microsphere. The spherical shape of the glass provides for increased reflective properties of the composition and allows for increased reflecting and scattering of UV, less likely with flake or other non-rounded shapes of glass. In an embodiment, the amount of glass may range from about 5 to about 25 wt. %, from about 8 to about 22 wt. %, from about 10 to about 20 wt. %, from about 12 to about 18 wt. %, and even from about 14 to about 16 wt. % of the composition. In an embodiment, the glass may be approximately 15.0878 wt. % of the composition. In an embodiment, the glass may be approximately 12.166 wt. % of the composition. It will be appreciated that the composition may include a combination of different types of glass materials. In an embodiment, there may be no glass in the composition.

A multitude of additives may also be included in the coating composition. The additives may typically be included in any appropriate level in the composition. However, even at relatively low levels in the coating composition formulation, the additives may contribute to various properties of the composition, including, but not limited to, rheology, stability, paint performance, and application quality. Examples of additives that may be included in the coating composition, include, but are not limited to, resin additives, performance additives, dispersing aids, anti-settling aids, wetting aids, additional thickeners, extenders, plasticizers, stabilizers, light stabilizers, antifoams, defoamers, catalysts, rheology modifiers, rheology additives, biocides including microbiocides and/or fungicides, texture-improving agents, UV-absorbers, anticorrosive agents, anti-slip aggregates, pigments, color indicators, and/or antifluccoulating agents. In one embodiment, the composition may include benzophenone as an additive. The amount and type of additives are usually determined by features of the other coating composition components. In an embodiment, the amount of additives may range from about 0.01 wt. % to about 20 wt. %, from about 2 to about 17 wt. %, from about 5 to about 15 wt. %, and even from about 8 to about 14 wt. % of the composition.

Certain additives, e.g., pigments, are added to provide a desired color for the coating composition. While certain pigments may be desirable or commonly used provide a particular color (or employed to provide a base coating composition that is used to formulate other colored compositions), it has been found that the exclusion of particular pigments provides a benefit in terms of reducing the surface temperature of the coating. In an embodiment, the coating composition may not include and is substantially free or completely free of carbon black as an additive. Carbon black is a commonly used black pigment that strongly absorbs UV radiation. For compositions containing carbon black, the solar reflectance may be less than about 20%, less than about 10%, and even less than about 5%. This results in increased light absorption and increased temperature of the coated substrate. Accordingly, coating composition that do not include carbon black may have increased solar reflectance values which contribute to decreased surface temperatures of substrates coated in the coating material as compared with substrates coated in a coating material containing carbon black. The lack of carbon black in the coating composition provides other benefits such as improved lifetime for the coating and substrate through reduced temperature strains.

In an embodiment, the coating composition may not include and is substantially free or free of raw umber as an additive. Raw umber is a commonly used pigment that strongly absorbs UV radiation. For compositions containing raw umber, the solar reflectance may be in the range of 65% to less than 30% depending on the concentration of raw umber in the formulation. This results in increased light absorption and increased temperature of the coated substrate. Accordingly, coating composition that do not include raw umber may have increased solar reflectance values which contribute to decreased surface temperatures of substrates coated in the coating material as compared with substrates coated in a coating material containing carbon black. The lack of raw umber in the coating composition provides other benefits such as improved lifetime for the coating and substrate through reduced temperature strains.

In one embodiment, the coating composition is free of both carbon black and raw umber.

The coating composition may also include a filler component. The filler may be any appropriate material, including, but not limited to, calcium carbonate, titanium dioxide, calcite, calcium, clay, silica, resins, aluminum oxide, carbon fibers, quartz, boron nitride, pumice, magnesium oxide and hydroxide, and talc. The amount and type of filler is usually determined by features of the other coating composition components. In an embodiment, the amount of filler may range from about 0 to about 25 wt. %, from about 5 to about 20 wt. %, and even from about 10 to about 15 wt. % of the composition.

The coating composition may also include colorants. The colorants may provide the composition with both decorative and protective features. Colorants are often liquid particles used to provide the composition with various qualities, including, but not limited to, color, opacity, and durability. The composition may also contain other solid particles such as polyurethane beads or other solids. The colorants may be present in any appropriate amount in the coating composition, including, but not limited to, about 0 to about 12 oz., about 2 to about 10 oz., about 4 to about 8 oz., and even from about 6 to about 7 oz. The colorants may vary based on the desired end color of the coating composition, the use of the coating composition, etc. Examples of suitable colorants include, but are not limited to, titanium dioxide, yellow iron oxide, red iron oxide, umber, phthalocyanine blue, phthalocyanine green, quinacridone red, diketopyrrolopyrrole red, naphthol red, quinacridone magenta, transparent iron oxides, carbazole violet, perylene red, bismuth vanadate yellow, arylide yellow, and diketopyrrolopyrrole orange. The colorants may be added during the original preparation of the composition or they may be added later at the time of purchase.

The coating composition can be prepared by mixing any or all of the following materials: the carrier, binder, thickener, glass, additive, filler and colorant. The components may be combined in any appropriate manner, e.g., sequentially, all at once, or in various stages. The colorants may be added during the original preparation of the composition or they may be added later when a customer selects a preferred shade, e.g., at the point of sale. Further, the glass microspheres may be added during the original preparation of the composition or they may be added later, e.g., at the point of sale. In an embodiment, the composition may be formed by the standard order of making typical coating compositions, i.e., non-cooling coating compositions. In an embodiment, these components may be formed in-situ. In another embodiment, the components may be preformed materials. The coating composition can be prepared at any appropriate temperature, including from about 20° C. to about 40° C.

The coating composition may have a pH in the range of from about 8 to about 10.5. After the initial mixing of the coating composition, it may be necessary to adjust the pH of the composition to fall within an appropriate range.

The coating composition can be applied by any suitable methods including, but not limited to, by brush, by roller, by spraying, by dipping, etc. Curing can be accomplished by any suitable curing mechanism including, for example, thermal condensation.

The coating composition can be applied to provide a coating layer of a desired thickness. In one embodiment, the coating composition has a thickness of from 0.5 micrometer to about 500 micrometers; from about 1 micrometer to about 300 micrometers; and even from about 3 micrometers to about 200 micrometers.

The coating composition can be used in a variety of applications where a cool coated surface is desired. The coating composition can be suitably coated onto a substrate such as concrete, brick, stucco, asphalt, wood, metal, plaster, roof shingles, or plastic. The coating composition may be applied with or without the use of a primer. The coating composition may be applied directly to a bare surface or onto a previously painted surface. The coating composition may be applied to interior and/or exterior surfaces. In an embodiment, the coating composition may be coated onto an outdoor deck or pavement surrounding a swimming pool and/or spa. The coating composition may be used to coat a surface and provide a cool surface on boats, stadiums, balconies, walkways, concrete and/or wooden decks/patios, pool decks, concrete floors, asphalt surfaces, such as roads, sidewalks, etc., recreational areas, garages, aquatic centers, dog parks, etc. The coating composition may be used to paint lines on roads, sidewalks or athletic courts, e.g., outdoor basketball courts, shuffleboard courts, tennis courts, etc. The coating composition may also be used on walls to maintain a cooler temperature in a room and/or outside of a building. Additionally, the coating composition may be used to coat roof shingles to keep the shingles cooler to the touch during application and then help to maintain a cooler environment in the building below.

Once the coating composition of the present technology is coated on a substrate, it may be allowed to dry, for example, by evaporation, thereby leaving a dry coating with the cool surface benefits. Any drips or misapplications of the coating composition may be easily cleaned up.

Once applied to a surface located in the presence of UV-radiation, the coating composition can reflect most heat away from the surface. As shown in FIG. 1, a coating composition 100 containing microspheres 120, lacking carbon black, lacking raw umber, or lacking both, and having a higher film build is applied to a surface 110. The surface 110 is exposed to a source of UV-light, e.g., the sun 140, which radiates UV-light 150 onto the coated surface 110. The majority of the UV-light 160 is reflected off the surface 130, and only a minimal amount of the UV-light 170 is absorbed and turned into heat. Further, the coating composition may allow for the scattering of UV-light off the surface. This allows for the coated surface to remain cooler in temperature than a surface coated with a conventional coating or a surface without a coating.

The present coating composition may include and/or exclude specific colorants in order to keep the temperature of a coated surface low. The inclusion/exclusion of certain colorants may allow for the increased reflection and scattering of UV-light, thereby keeping the temperature of the coated surface lower as compared to coatings by compositions with/without these certain colorants. For example, the coating composition may exclude carbon black, raw umber, or both carbon black and raw umber. The result of excluding and/or include specific colorants may allow for a temperature differential of at least 10° F.

Further, the present coating composition may include thickeners and/or rheology modifiers (e.g., hydroxyethyl cellulose) that allow for a high film build. This high film build allows for an increased viscosity and thickness of the coating composition, which creates an increased reflection and scattering of light, thereby keeping the temperature of the coated surface lower as compared to coatings without thickeners and/or rheology modifiers. The incorporation of thickeners and/or rheology modifiers in specific amounts may result in a temperature differential of at least 10° F.

Additionally, the present coating composition includes glass that allows for the increased reflection and scattering of UV-light, thereby keeping the temperature of the coated surface lower as compared to coatings by compositions without the glass. The incorporation of glass in specific amounts may result in a temperature differential of at least 10° F.

In an embodiment, the coating composition may include glass. In an embodiment, the coating composition may include glass and a high film build. In an embodiment, the coating composition may include glass, a high film build, no carbon black, and/or no raw umber. In an embodiment, the coating composition may include glass and no carbon black, and/or no raw umber. In an embodiment, the coating composition may include a high film build and no carbon black, and/or no raw umber. In an embodiment, the coating composition may include a high film build. In an embodiment, the coating composition may include no carbon black, and/or no raw umber.

Together or separately, these concepts can result in a coating composition that, when applied to a surface, can result in reduced surface temperatures of over 25° F. as compared to a surface coated with a conventional coating or a bare/uncoated surface exposed to the same UV light. In an embodiment, the surface temperature of a coated article can be reduced by over 10° F., over 15° F., over 20° F., over 30° F., over 35° F., over 40° F., over 45° F., and even over 50° F. This can result in a surface temperature that is over 5% cooler, over 10% cooler, over 15% cooler, over 20% cooler, over 25% cooler, over 30% cooler, 35% cooler, over 40% cooler, over 45% cooler, and even over 50% cooler than surfaces coated with a conventional coating.

Furthermore, the present coating composition can allow for a solar reflectance of at least 10% more, at least 15% more, at least 20% more, at least 25% more, at least 30% more, at least 35% more, at least 40% more, at least 45% more, at least 50% more, at least 55% more, at least 60% more, at least 65% more, at least 70% more, at least 75% more, and even at least 80% more than surfaces coated with a conventional coating.

The reduced surface temperature and increased solar reflectance of the coating composition provides for other benefits such as improved lifetime for the coating and coated substrate through reduced temperature strains. Further, the coating composition allows for a variety of color tints and hues through its formulation.

The present technology may be incorporated into a latex paint coating, a solvent-based paint coating, a sealant, a waterproofing material, a floor cleaner and/or wax, or any other appropriate solution that could benefit from a reduced surface temperature on the materials upon which it is being coated.

The present coating composition may provide other benefits such as resistance to slipperiness around water and other liquids as compared to conventional pool and similar coatings. The application of the present coating composition may reduce slip and fall injuries and other related accidents near swimming pools, hot tubs, bathtubs, etc. Furthermore, the coating composition is resistant to pool chemicals such as chlorine, bromine, algaecide, etc., along with many other household chemicals for long-lasting coating protection and appearance.

While the technology has been described with reference to various exemplary embodiments, it will be appreciated that the modifications may occur to those skilled in the art, and the present application is intended to cover such modifications and invention as fall within the spirit of the invention. Further, it should be noted that throughout the specification and claims, numerical values may be combined to form new and non-disclosed ranges

The following examples are illustrative and not to be construed as limiting of the technology as disclosed and claimed herein.

### EXAMPLES

### Example 1

For all of the examples, the following formulations of coating compositions were used.

A control composition comprising a general latex paint formulation was produced.

A prototype composition including the general latex paint formulation of the control composition along with 12.1660 wt. % SCOTCHLITE K46 glass microspheres and 0.4136 wt. % Natrosol H₄Br was produced.

### Example 2

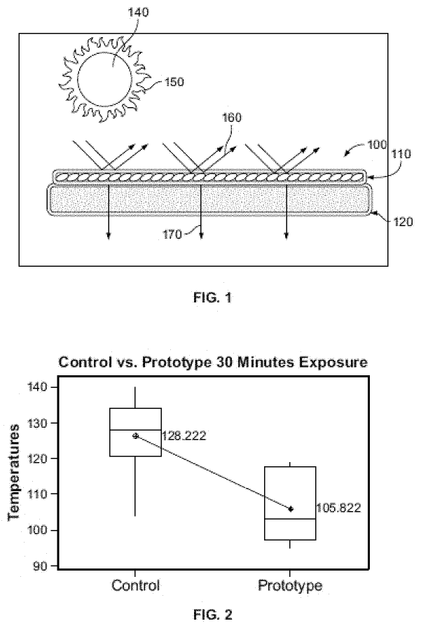

A control composition and a prototype composition were prepared substantially in accordance with that of Example 1. Both the control and prototype compositions were tinted to 18 various colors. Two coats each of the control and prototype compositions were roll-applied over 12×12 concrete blocks. The control and prototype compositions were applied over the same block to reduce substrate to substrate variation. The blocks were placed under 2 GE Halogen 100 W 120 V lamps for 30 minutes in the laboratory. The surface temperatures of the coated surfaces were measured using a handheld IR temperature gun at various time intervals from 2-240 minutes. As shown in FIG. 2, the mean temperature of the control composition was 118.7° F. with a standard deviation of 10.3° F. and the mean temperature of the prototype composition was 102.44° F. with a standard deviation of 10.3° F.

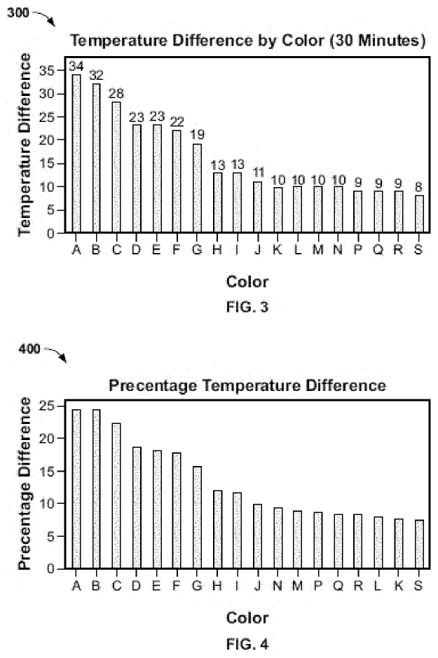

FIG. 3 is a bar graph comparing the temperature differences of the control versus the prototypes for all 18 colors. For example, there was a 34° F. difference between the temperature of the blueberry control and blueberry prototype after both samples were exposed to 30 minutes of exposure under UV lamps in the laboratory.

FIG. 4 is a bar graph depicting the percentage temperature difference for the control and prototype compositions by color.

### Example 3

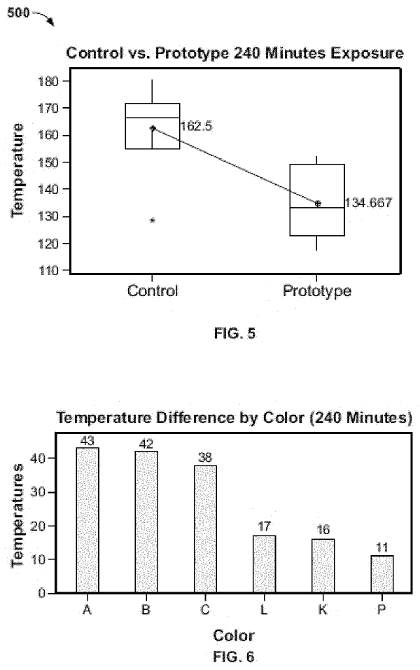

A control composition and a prototype composition were prepared substantially in accordance with that of Example 1. Both the control and prototype compositions were tinted to 18 various colors. Two coats each of the control and prototype compositions were roll-applied over 12×12 concrete blocks. The control and prototype compositions were applied over the same block to reduce substrate to substrate variation. The blocks were placed under 2 GE Halogen 100 W 120 V lamps for 240 minutes in the laboratory. The surface temperatures of the coated surfaces were measured using a handheld IR temperature gun at various time intervals from 2-240 minutes. The mean temperature of the control composition was 162.5° F. with a standard deviation of 17.9° F. and the mean temperature of the prototype composition was 134.7° F. with a standard deviation of 13.7° F. The results are shown in FIG. 5.

FIG. 6 is a bar graph comparing the temperature differences of the control versus the prototypes for all 18 colors. For example, there was a 43° F. difference between the temperature of the blueberry control and blueberry prototype after both samples were exposed to 240 minutes of exposure under UV lamps in the laboratory.

### Example 4

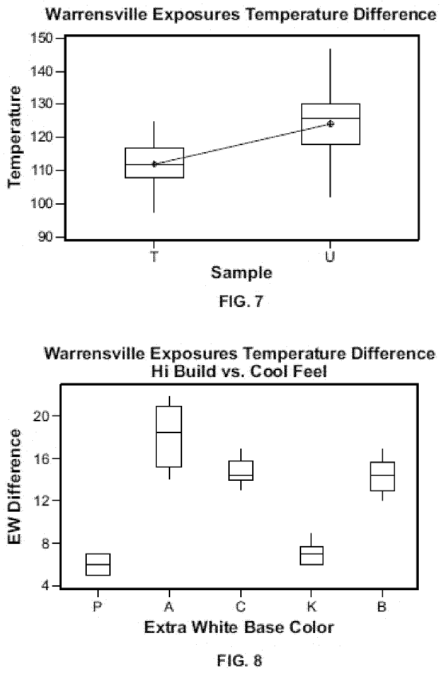

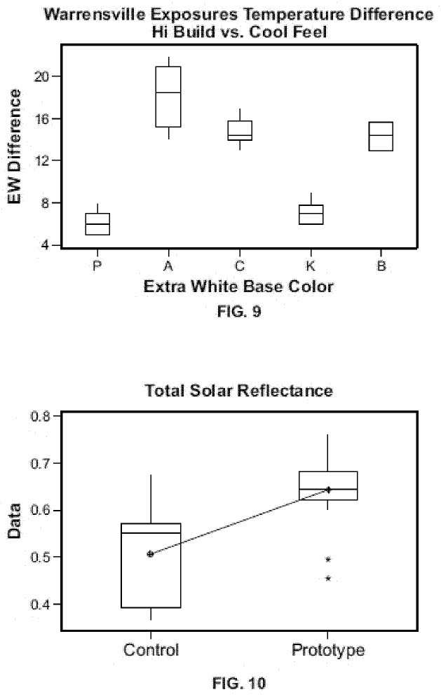

A control composition and a prototype composition were prepared substantially in accordance with that of Example 1. Both the control (here, Sample A) and prototype (here, Sample B) compositions were tinted to 5 various colors. The control and prototype compositions were coated side-by-side onto concrete slabs and exposed to multiple days of external exposure in Warrensville, Ohio. The surface temperatures of the coated surfaces were intermittently measured using a handheld IR temperature gun at various external temperatures ranging from 74° F.−89° F. The mean temperature of the control composition was 124.3° F. with a standard deviation of 10.0° F. and the mean temperature of the prototype composition was 112.13° F. with a standard deviation of 6.47° F. The results are shown in FIG. 7.

FIG. 8 is a boxplot comparing the temperature differences of the control versus the prototypes for all 5 colors tested. For example, there was a 22° F. difference between the temperature of the blueberry control and blueberry prototype after both samples were exposed to external conditions.

### Example 5

A control composition and a prototype composition were prepared substantially in accordance with that of Example 1. Both the control and prototype compositions were tinted to 18 various colors. Two coats each of the control and prototype compositions were roll-applied over 12×12 concrete blocks. The control and prototype compositions were applied over the same block to reduce substrate to substrate variation. The control and prototype compositions were measured for total solar reflectance near ambient temperature using ASTM C1549 and a portable solar reflectometer. The control composition has a mean total solar reflectance of 0.507 SRI with a standard deviation of 0.107. The control composition has a mean total solar reflectance of 0.6446 SRI with a standard deviation of 0.0790. The results are shown in FIG. 10.

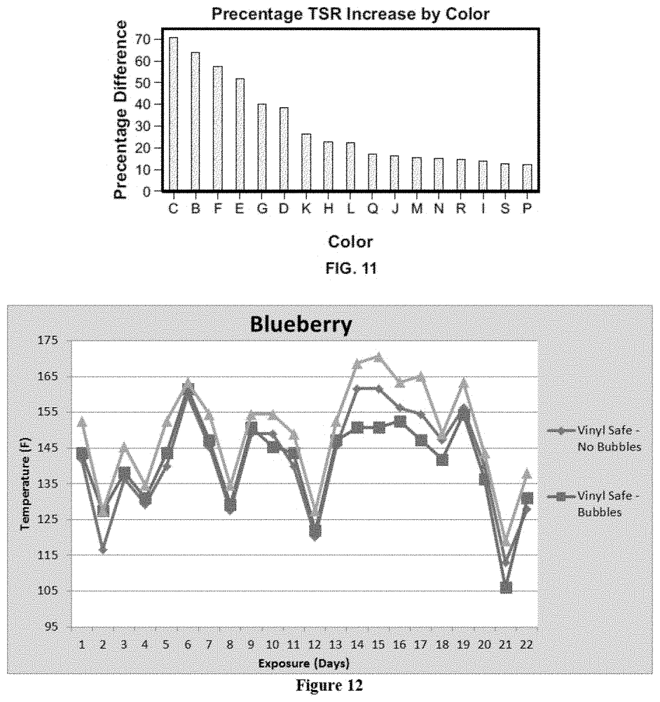

FIG. 11 is a bar graph highlighting the total solar reflectance percentage increase for the prototypes versus the control for all 18 colors. As shown in the graph, two of the colors have over a 60% increase in total solar reflectance when comparing the control and prototype in the same color.

### Examples 6-12

For the following Examples 6-12, the temperature testing was conducted at a testing center in Arizona over a period of 22 days. The test included a control (present technology without glass bubbles and with non-vinyl safe colorants), prototype (present technology with glass bubbles and with non-vinyl safe colorants), and a competitive product. The resin system in all but the competitive product is a 100% self crosslinking acrylic. ASTM G147-2017 Standard Practice for Conditioning and Handling of Nonmetallic Materials for Natural and Artificial Weathering Tests and ASTM G7-2013 Standard Practice for Atmospheric Environmental Exposure Testing of Nonmetallic Materials were cited in the testing process.

The testing data was compiled by adding the composition to a horizontal concrete pad over a 22 day period from August to September. Temperature measurements were taken on each coating and bare concrete using an Omega OS534 IR Gun, between Noon and 3 PM. The IR Gun was allowed to warm up for 2-4 minutes prior to taking measurements (E=0.95). Each color was applied in two coats, with the second coat applied perpendicular to first coat with minimum two hour dry time between coats, over a 1′×2′ area using 9″ roller with ⅜″ nap. Weather conditions varied from cloudy/windy to clear skies and ambient temperatures ranged from 89.6° F. to 104° F. with humidity ranging from 11% to 41% during these measurements.

### Example 6

A vinyl safe without glass prototype composition including a first latex paint formulation of the control composition without glass microspheres and vinyl safe components was produced as well as a vinyl safe with glass prototype composition including the general latex paint formulation of the control composition along with glass microspheres and vinyl safe components. These compositions all included about 4.0 oz. of black colorant.

As shown in FIG. 12, the vinyl safe with glass composition had a measured temperature difference range of 0 to −19.8° F., and the vinyl safe without glass composition had a measured temperature difference range of −2.7 to −12.6° F. The vinyl safe with glass composition had an average temperature of 141.0° F., the vinyl safe without glass composition had an average temperature of 141.7° F. and the control average temperature of 149° F.

### Example 7

A vinyl safe without glass prototype composition including a first latex paint formulation of the control composition without glass microspheres and vinyl safe components was produced as well as a vinyl safe with glass prototype composition including the general latex paint formulation of the control composition along with glass microspheres and vinyl safe components. These compositions all included about 0.5 oz. of black colorant.

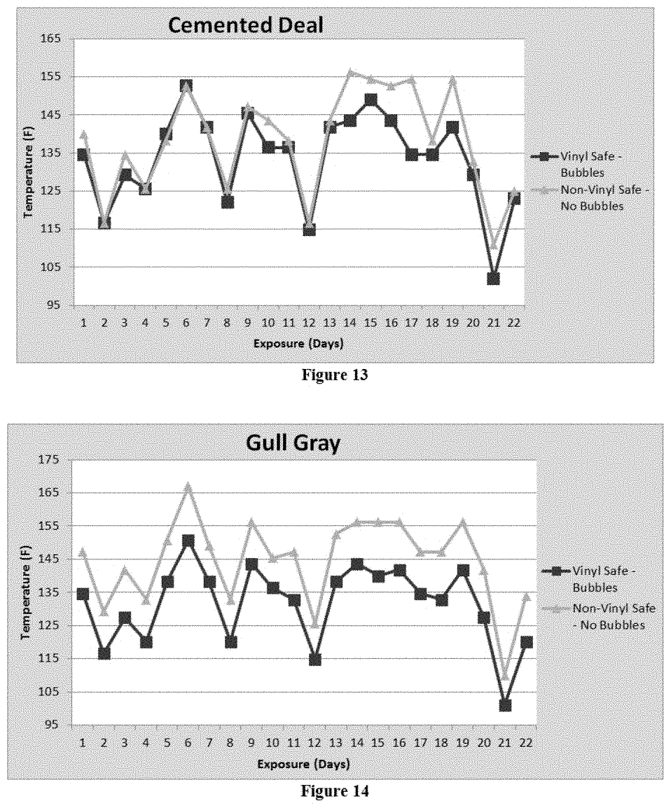

As shown in FIG. 13, the vinyl safe with glass composition had a measured temperature difference range of +1.8 to −19.8° F., and had an average temperature of 133.6° F., whereas the control average temperature of 138.3° F.

### Example 8

A vinyl safe without glass prototype composition including a first latex paint formulation of the control composition without glass microspheres and vinyl safe components was produced as well as a vinyl safe with glass prototype composition including the general latex paint formulation of the control composition along with glass microspheres and vinyl safe components. These compositions all included about 1.2 oz. of black colorant.

As shown in FIG. 14, the vinyl safe with glass composition had a measured temperature difference range of −9.0 to −16.2° F., and had an average temperature of 131.6° F., whereas the control average temperature of 144.7° F.

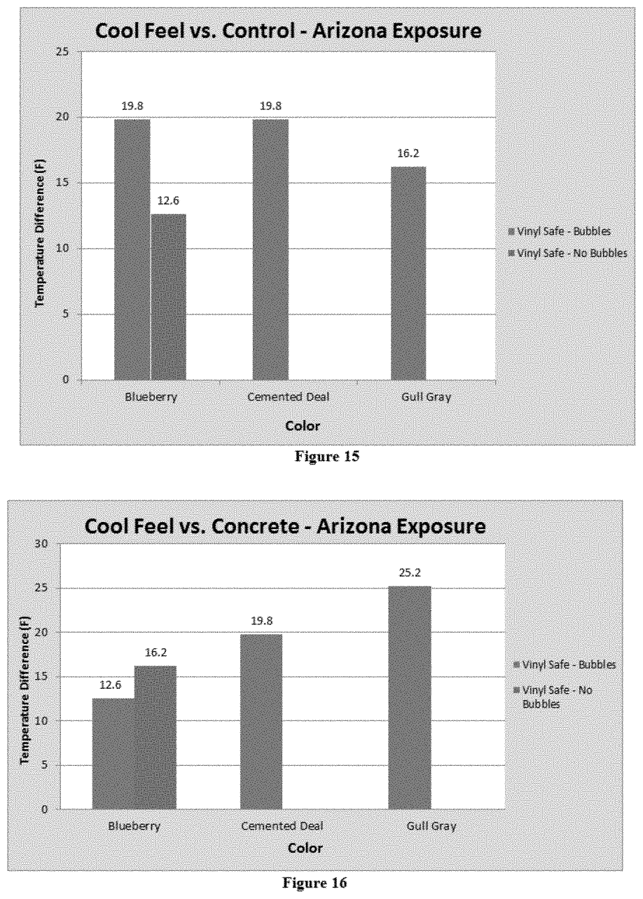

FIG. 15 is a bar graph comparing the temperature differences of the control versus the prototypes for all three colors—blueberry, cemented deal and gull gray. For example, there was a 19.8° F. difference between the temperature of the blueberry control and blueberry prototype vinyl safe with glass composition and a 12.6° F. difference between the temperature of the blueberry control and blueberry prototype vinyl safe without glass after both samples were exposed.

FIG. 16 is a bar graph comparing the temperature differences of concrete versus the prototypes for all three colors—blueberry, cemented deal and gull gray. For example, there was a 12.6° F. difference between the temperature of the blueberry control and blueberry prototype vinyl safe with glass composition and a 16.2° F. difference between the temperature of the blueberry control and blueberry prototype vinyl safe without glass after both samples were exposed. The bare concrete temperature ranged from 112 to 161.6° F. Blueberry vinyl safe with glass composition had a measured temperature difference range of +5.5 to −12.6° F. and Blueberry vinyl safe without bubbles composition had a measured temperature difference range of +3.6 to −16.2° F. as compared to bare concrete. Cemented Deal vinyl safe with glass composition had a measured temperature difference range of 0 to −19.8° F. as compared to bare concrete. Gull Gray vinyl safe with glass composition had a measured temperature difference range of −5 to −25.2° F. as compared to bare concrete.

### Example 9

A vinyl safe without glass prototype composition including a second latex paint formulation of the control composition without glass microspheres and vinyl safe components was produced as well as a vinyl safe with glass prototype composition including the general latex paint formulation of the control composition along with glass microspheres and vinyl safe components. These compositions all included about 4.0 oz. of black colorant.

As shown in FIG. 17, the vinyl safe with glass composition had a measured temperature difference range of −7.2 to −21.6° F., and the vinyl safe without glass composition had a measured temperature difference range of −8.0 to −25.2° F. The vinyl safe with glass composition had an average temperature of 140.9° F., the vinyl safe without glass composition had an average temperature of 140.0° F. and the control average temperature of 152.5° F.

### Example 10

A vinyl safe without glass prototype composition including a second latex paint formulation of the control composition without glass microspheres and vinyl safe components was produced as well as a vinyl safe with glass prototype composition including the general latex paint formulation of the control composition along with glass microspheres and vinyl safe components. These compositions all included about 0.5 oz. of black colorant.

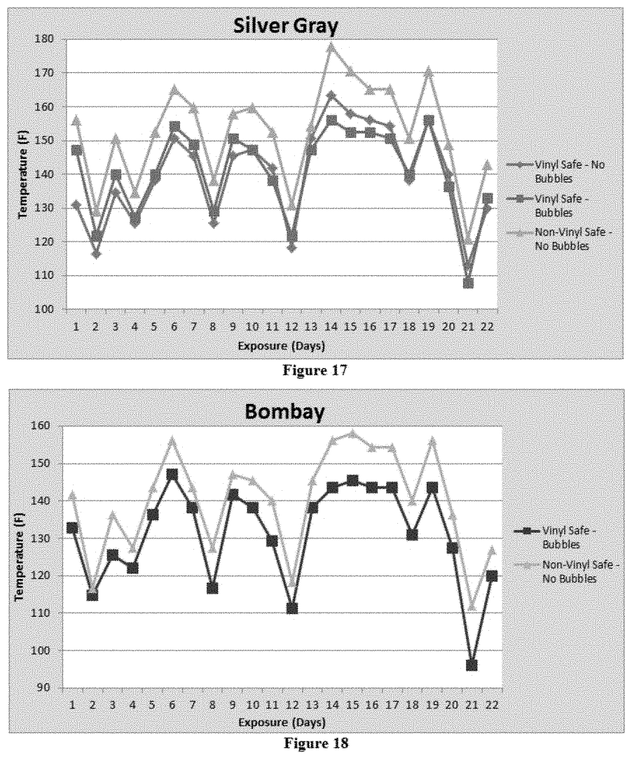

As shown in FIG. 18, the vinyl safe with glass composition had a measured temperature difference range of −1.8 to −16.0° F., and had an average temperature of 131.2° F., whereas the control average temperature of 140.2° F.

### Example 11

A vinyl safe without glass prototype composition including a second latex paint formulation of the control composition without glass microspheres and vinyl safe components was produced as well as a vinyl safe with glass prototype composition including the general latex paint formulation of the control composition along with glass microspheres and vinyl safe components. These compositions all included about 1.2 oz. of black colorant.

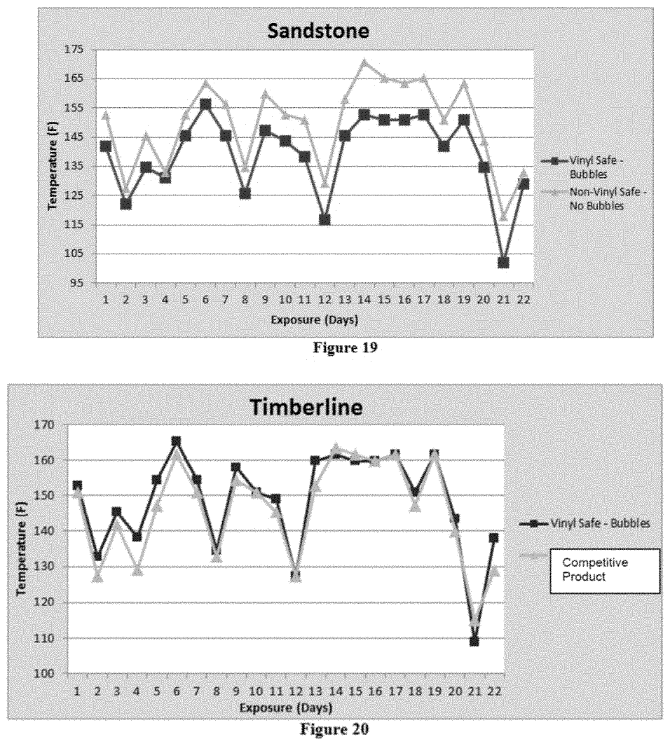

As shown in FIG. 19, the vinyl safe with glass composition had a measured temperature difference range of −1.8 to −18.0° F., and had an average temperature of 139.0° F., whereas the control average temperature of 149.5° F.

### Example 12

A vinyl safe with glass prototype composition including a second latex paint formulation was produced and compared to a competitive product.

As shown in FIG. 20, the vinyl safe with glass composition had a measured temperature difference range of +12.6 to −3.0° F., and had an average temperature of 148.6° F., whereas the control average temperature of 146° F.

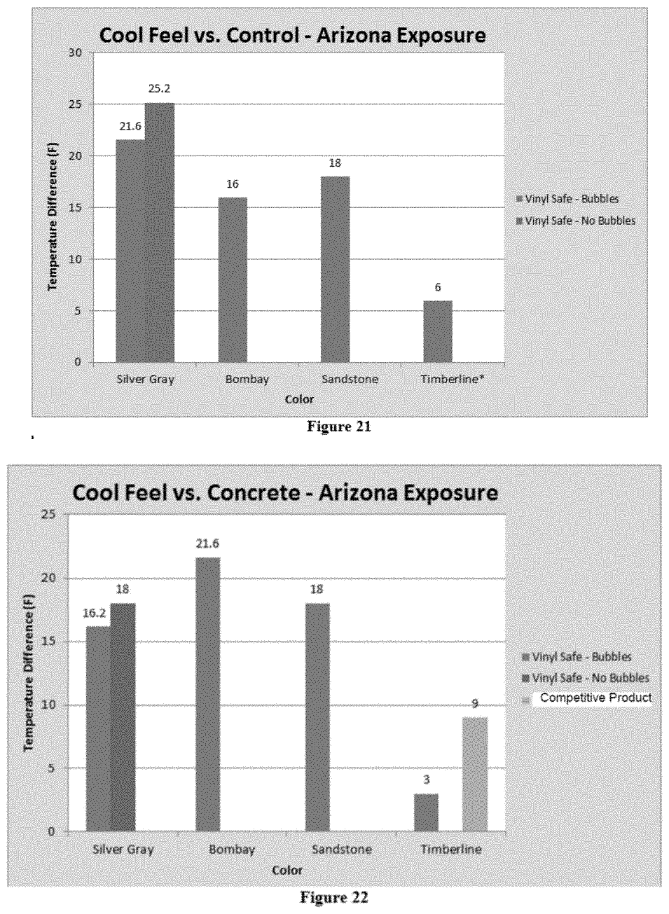

FIG. 21 is a bar graph comparing the temperature differences of the control versus the prototypes for all four colors—Silver Gray, Bombay, Sandstone, and Timberline. For example, there was a 21.6° F. difference between the temperature of the Silver Gray control and Silver Gray prototype vinyl safe with glass and a 25.2° F. difference between the temperature of the Silver Gray control and Silver Gray prototype vinyl safe without glass after both samples were exposed.

FIG. 22 is a bar graph comparing the temperature differences of concrete versus the prototypes for all four colors—Silver Gray, Bombay, Sandstone, and Timberline, along with a competitive product. For example, there was a 16.2° F. difference between the temperature of the Silver Gray control and Silver Gray prototype vinyl safe with glass and a 18° F. difference between the temperature of the Silver Gray control and Silver Gray prototype vinyl safe without glass after both samples were exposed. The bare concrete temperature ranged from 112 to 161.6° F. Silver Gray vinyl safe with glass composition had a measured temperature difference range of +8 to −16.2° F. and Silver Gray vinyl safe without bubbles composition had a measured temperature difference range of +6 to −18° F. as compared to bare concrete. Bombay vinyl safe with glass composition had a measured temperature difference range of −3.6 to −21.6° F. as compared to bare concrete. Sandstone vinyl safe with glass composition had a measured temperature difference range of +5.5 to −12.6° F. as compared to bare concrete. Timberline vinyl safe with glass composition had a measured temperature difference range of +12.6 to −3° F. as compared to bare concrete, while the competitive product had a measured temperature difference range of +4 to −9° F. as compared to bare concrete.

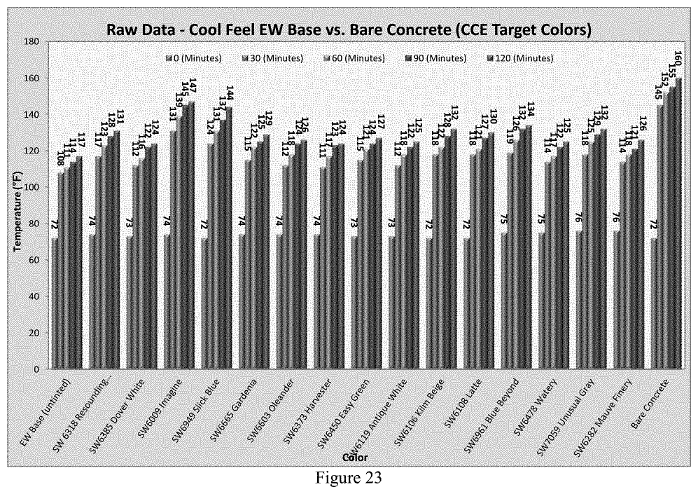

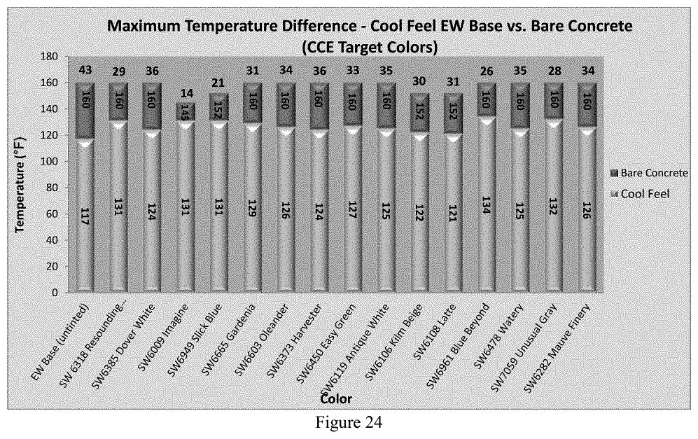

FIGS. 23-26 are graphs showing the temperature differences of different colors compared to bare concrete. The colors are colors from the Sherwin Williams color palette and each represent a different color space within the color spectrum of the Sherwin Williams palette. Temperature data was compiled under lab test conditions via heat lamp using dual GE 100 W halogen flood light bulbs over 6″×12″×½″ concrete. Each color sample was applied in 2 coats using a ⅜″ mini roller. The light bulbs were kept at a distance of about 7.5″ to the block. Temperature measurements were taken every 30 minutes for a total of 2 hours using a calibrated Raytek Raynger ST Handheld Infrared Thermometer. After two hours of exposure the panels started to reach maximum temperature, and additional readings were not necessary.

FIGS. 23 and 24 show the results for different colors formulated off of a base white coat that is tinted with appropriate colorants to form the desired color. The white base coat itself is a viable color option for consumers and the surface temperature of a coating of the base composition is also tested. FIG. 23 shows the temperature of the coated surfaces and bare concrete at 0 minutes, 30 minutes, 60 minutes, 90 minutes, and 120 minutes. FIG. 24 shows the temperature difference between the coated surface and bare concrete at 120 minutes. As illustrated, the different colors exhibit surface temperature reduction relative to bare concrete over a broad range of colors in the color palette.

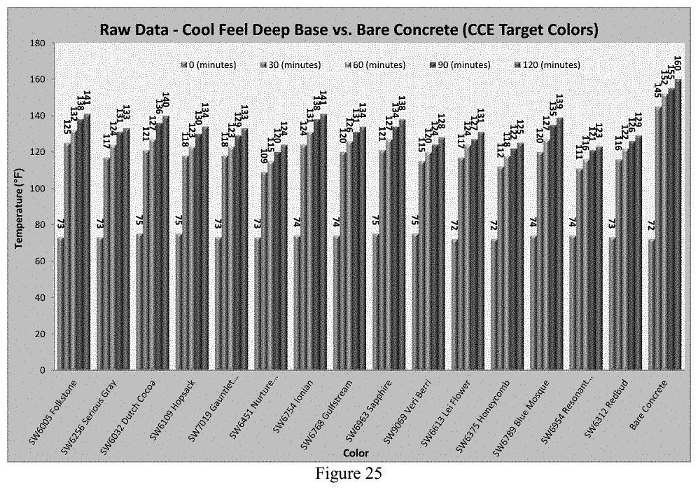

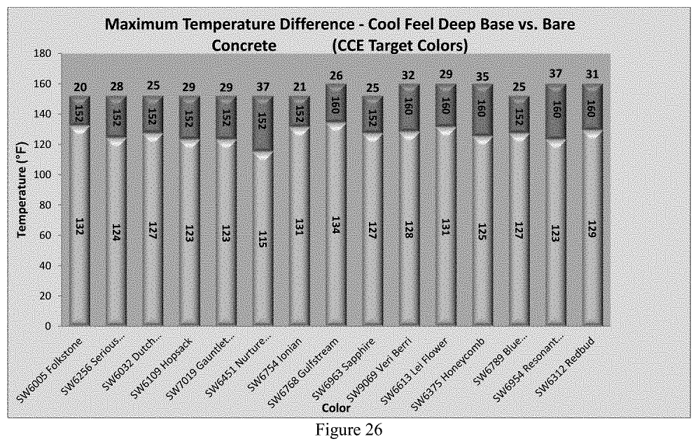

FIGS. 25 and 26 show the results for different colors formulated off of a base formulation that is tinted with appropriate colorants to form the desired color. FIG. 23 shows the temperature of the coated surfaces and bare concrete at 0 minutes, 30 minutes, 60 minutes, 90 minutes, and 120 minutes. FIG. 24 shows the temperature difference between the coated surface and bare concrete at 120 minutes. As illustrated, the different colors exhibit surface temperature reduction relative to bare concrete over a broad range of colors in the color palette.

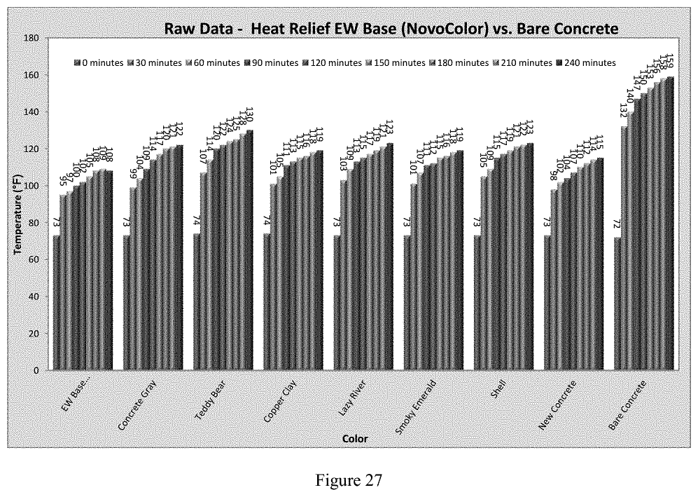

FIGS. 27-30 are graphs showing the temperature differences of different colors compared to bare concrete. The colors are colors from the Valspar color palette and each represent a different color space within the color spectrum of the Valspar palette. Temperature data was compiled under lab test conditions via heat lamp using dual GE 100 W halogen flood light bulbs over 7¾″×15¾″×1¾″ concrete patio block. Each color sample was applied in 2 coats using a ⅜″ mini roller. The light bulbs were kept at a distance of about 7.5″ to the block. Temperature measurements were taken every 30 minutes for a total of 4 hours using a calibrated Raytek Raynger ST Handheld Infrared Thermometer. After four hours of exposure the panels started to reach maximum temperature, and additional readings were not necessary.

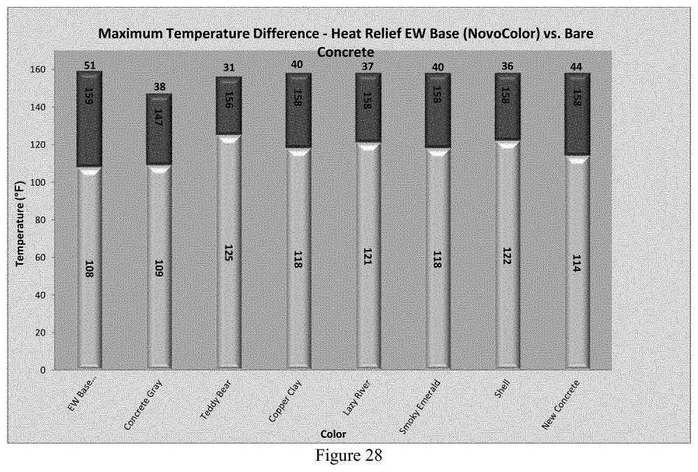

FIGS. 27 and 28 show the results for different colors formulated off of a base white coat that is tinted with appropriate colorants to form the desired color. The white base coat itself is a viable color option for consumers and the surface temperature of a coating of the base composition is also tested. FIG. 27 shows the temperature of the coated surfaces and bare concrete at 0 minutes, 30 minutes, 60 minutes, 90 minutes, 120 minutes, 150 minutes, 180 minutes, 210 minutes, and 240 minutes. FIG. 28 shows the temperature difference between the coated surface and bare concrete at 240 minutes. As illustrated, the different colors exhibit surface temperature reduction relative to bare concrete over a broad range of colors in the color palette.

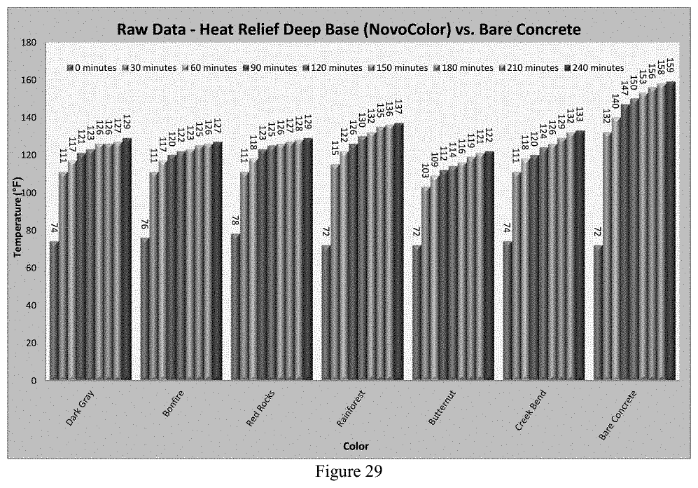

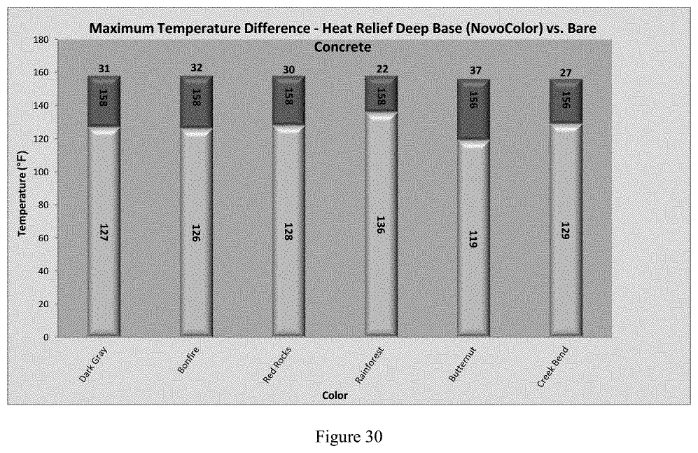

FIGS. 29 and 30 show the results for different colors formulated off of a base formulation that is tinted with appropriate colorants to form the desired color. FIG. 29 shows the temperature of the coated surfaces and bare concrete at 0 minutes, 30 minutes, 60 minutes, 90 minutes, 120 minutes, 150 minutes, 180 minutes, 210 minutes, and 240 minutes. FIG. 30 shows the temperature difference between the coated surface and bare concrete at 120 minutes. As illustrated, the different colors exhibit surface temperature reduction relative to bare concrete over a broad range of colors in the color palette.

The test results show that the present technology enables the maintenance of a cooler surface temperature than the same tint of composition in a control version, due at least in part, to solar reflectance.

This application incorporates each of U.S. Publication 2019/0031893 and WO 2017/124096 by reference in their entirety.

While the above description contains many specifics, these specifics should not be construed as limitations on the scope of the invention, but merely as exemplifications of preferred embodiments thereof. Those skilled in the art may envision many other possible variations that are within the scope and spirit of the invention as defined by the claims appended hereto.

What is claimed is:

1. A coating composition comprising:
(a) a carrier;
(b) a binder;
(c) a thickener;
(d) a spherical-shaped glass;
(e) an additive;
wherein the composition is free of raw umber.

2. The coating composition of claim 1 further comprising a filler.

3. The coating composition of claim 1, wherein the composition comprises 0.1-5 wt. % thickener.

4. The coating composition of claim 1, wherein the thickener is hydroxyethyl cellulose.

5. The coating composition of claim 1, wherein the composition comprises 10-20 wt. % glass.

6. The coating composition of claim 1, wherein the glass is borosilicate.

7. The coating composition of claim 1 further comprising colorants.

8. The coating composition of claim 1, wherein the composition exhibits high film build.

9. The coating composition of claim 1, wherein the composition is free of carbon black.

10. A coating composition comprising:
(a) a carrier;
(b) a binder;
(c) a thickener configured to create a high film build;
(d) an additive;
wherein the composition is free of raw umber.

11. The coating composition of claim 10 further comprising a filler.

12. The coating composition of claim 10, wherein the composition comprises 0.1-5 wt. % thickener.

13. The coating composition of claim 10, wherein the thickener is hydroxyethyl cellulose.

14. The coating composition of claim 10 further comprising glass.

15. The coating composition of claim 14, wherein the glass is borosilicate.

16. The coating composition of claim 10 further comprising colorants.

17. The coating composition of claim 10, wherein the composition is free of carbon black.

18. An article comprising:
a substrate defining a surface; and
a coating composition deposited upon the surface,
wherein the coating composition comprises:
(a) a carrier;
(b) a binder;
(c) a thickener;
(d) a spherical-shaped glass;
(e) an additive;
wherein the composition is free of raw umber.

19. The article of claim 18, wherein the coating composition further comprises a filler.

20. The article of claim 18, wherein the coating composition comprises 0.1-5 wt. % thickener.

21. The article of claim 18, wherein the thickener of the coating composition is hydroxyethyl cellulose.

22. The article of claim 18, wherein the coating composition comprises 10-20 wt. % glass.

23. The article of claim 18, wherein the glass of the coating composition is borosilicate.

24. The article of claim 18, wherein the coated surface has a solar reflectance of at least 25% more than a surface coated with a conventional coating.

25. The article of claim 18, wherein the coated surface has a reduced surface temperature of over 20° F. over a surface coated with a conventional coating.

26. The article of claim 18, wherein the spherical-shaped glass reflects UV light.

27. The article of claim 18, wherein the coating composition has a high film build.

28. The article of claim 18, wherein high film build reflects UV light.

29. The article of claim 18, wherein the coating composition is free of carbon black.
